(19) United States
(12) Patent Application Publication
(10) Pub. No.: US 2004/0078390 A1
(43) Pub. Date: Apr. 22, 2004

(54) Information system and method for gathering information relating to livestock

(76) Inventor: John Saunders, Platte City, MO (US)

Correspondence Address: THOMAS B. LUEBBERING, HOVEY WILLIAMS LLP, Suite 400, 2405 Grand, Kansas City, MO, 64108, US

(21) Appl. No.: 10/278,876

(22) Filed: Oct. 22, 2002

(51) Int. Cl. G06F 17/00; G06F 7/00

(52) U.S. Cl. 707/104.1

(57) ABSTRACT

A livestock information system (10) for gathering information relating to livestock, such as calves, and making that information available for a variety of purposes. The system broadly comprises one or more site databases (12) each accessible by one or more site terminals (14) and a central database (16) for storing information relating to each of a plurality of calves (18). The site databases (12) preferably store information about each calf (18) collected through the site terminals (14). The site terminals (14) preferably include or connect to a scanner (20) to scan each of a plurality of unique tags (22) attached to one of the calves (18) and an input device to enter information about each calf (24). The information is preferably gathered frequently and made available even after the calves (18) have been slaughtered. Thus, owners, retailers, consumers, and other interested parties may learn about meat products they purchase.

### BACKGROUND OF THE INVENTION

1. Field of the Invention

The present invention relates to livestock information systems and methods. More particularly, the present invention relates to a livestock information system and method for gathering information relating to livestock, such as calves, and making that information available for a variety of purposes, such as source verification, traceability, and country of origin labeling of meat products and by-products.

2. Description of Prior Art

The cattle industry operates like many other industries in that information must be gathered and shared during the course of normal business. Information is useful, and in some cases required, for handling day-to-day business matters. Additionally, information helps breeders, cattle owners, bankers, and others make long-term strategic decisions. Therefore, many people rely on livestock information systems to track information, such as physical characteristics and medical details.

Current livestock information systems are ill-equipped to conveniently gather and share information relating to livestock. Paper systems typically consist of farm hands recording information in paper records, such as forms and tables. Paper records make analyzing or sharing information tedious and inefficient. For example, information contained in forms or tables often must be transcribed into charts or graphs to make the information easier to analyze. Additionally, people must have physical access to paper records in order to obtain desired information. Therefore, in order to share information, paper records must be copied and sent to people otherwise unable to access them. Furthermore, processes used in gathering and manipulating information in paper records are highly dependent upon human effort and thus, susceptible to human error.

Paper records are also difficult to work with in harsh weather conditions. For example, paper records may blow away in high winds or be destroyed by rain. Thus, paper forms are inefficient, subject to a high degree of human error, and cannot withstand harsh conditions.

More modern computerized systems use computers to store information, making analyzing and sharing the information more efficient. However, computers are extremely sensitive to harsh weather conditions and are easily damaged. For example, snow, rain, or excessive heat often destroys computers. Thus, many computer systems are not well suited to being used outdoors, where information relating to livestock must be gathered.

Additionally, both paper systems and computer systems typically do not make information available after livestock have been slaughtered. Thus, retailers and final consumers cannot learn the history of meat products they purchase and/or consume. The desire to obtain such information is growing as more people become concerned about livestock diseases, such as mad-cow disease, and other livestock issues, such as antibotics used in cattle production and cloning.

Furthermore, today's retail meat products suffer from several disadvantages. One disadvantage is that most meat products are treated as commodities and their price is largely market driven. Market forces tend to reduce quality of meat products and lead to other disadvantages, such as inconsistency between the same types of meats. For example, consumers often complain that their filet steaks differ in quality and taste each time they are purchased.

Each time consumers experience poor quality in other types of foods and products, those consumers are driven to avoid certain brands for their next purchase. However, the same cannot be done with meat products because meat products are typically not branded. Therefore, consumers currently have no way of gauging quality of current meat products until after they have been purchased and prepared. Thus, consumers have no reason to seek specific brands.

Accordingly, there is a need for an improved livestock information system that overcomes the limitations of the prior art.

### SUMMARY OF THE INVENTION

The present invention overcomes the above-identified problems and provides a distinct advance in the art of livestock information systems and methods. More particularly, the present invention provides a livestock information system and method for gathering information relating to livestock, such as calves, and making that information available for a variety of purposes, such as source verification, traceability, and country of origin labeling of meat products and by-products. Additionally, the system may be used for tracking the progress of the calves from conception until they are reduced to meat products and by-products. The preferred system broadly comprises one or more site databases each accessible by one or more site terminals and a central database for storing information relating to each of a plurality of calves. The site databases preferably store information about each calf collected through the site terminals.

The site terminals preferably include or connect to a scanner to scan each of a plurality of unique tags attached to one of the calves and an input device to enter information about each calf. The tags are preferably some form of electronically readable tag, allowing each calf to be electronically identified by the scanner. For example, the tags are preferably electronic chip tags that respond to radio frequency signals. The scanner is preferably able to transmit and receive the radio frequency signals thereby reading the tags and uniquely identifying each calf.

The input device is preferably a conventional keyboard, but may be a touchscreen, a mouse, or any other device commonly used for entering information into a computer. Additionally, the input device may include a scale to weigh each calf and automatically enter each calf's weight into the site terminal. Furthermore, the input device may include a specialized device designed to collect information about the calves, such as a ultrasound device, a thermometer, and/or a height measuring device. A monitor may be used in conjunction with the input device to verify the information as it is being entered into the site terminal.

In one embodiment, the site terminals are small hand-held personal data assistants (PDA), such as those available from Palm, Inc., Handspring, Inc., Compaq, Toshiba, or similar devices with an integrated infrared (IR) communications port allowing wireless communication with the site database. Such devices allow the site terminals to be extremely portable, durable, and easy to operate in harsh outdoor weather conditions, such as summer heat, winter cold, and rain. Additionally, wireless communication alleviates the need for wires which are susceptible to damage, making the entire system more reliable.

The site database preferably periodically transmits information collected about the calves to the central database over a network. The site database may automatically initiate a connection with the central database or the central database may automatically initiate the connection with the site database. Alternatively, the technician may manually initiate the connection or the connection may be maintained substantially continuously. The connection is preferably a secure network connection, such as a virtual private network (VPN) or a dial-up link.

As discussed above, the central database may receive and store information collected through several site databases. Therefore, the central database may store information relating to a large number of calves dispersed among several locations spread over a wide geographical area. The central database is preferably accessible over the Internet, thereby making the information stored therein accessible through a website. Thus, the central database and the website allow the information to be accessible from any location with access to the Internet.

The information may include physical characteristics, such as each calf's weight, height, size, and color. The information may also include genetic information, such as each calf's lineage, blood test results, and information derived from a DNA sample. The information may also include health and treatment information, such as injuries sustained by, diseases contracted by, and vaccinations or other medial care given to each calf. The information may also include dietary and nutritional information, such as each calf's feeding habits, growth rate, and body fat percentage. The information may also comprise other data, such as each calf's location and information relating to ownership of each calf. Finally, the information may include pictures and images of each calf, meat products derived from each calf, or both.

The information may be used to make predictions, such as predicting when more supplies are needed at each location by comparing current stock with consumption rates and anticipated increases in consumption rates of the calves. The information may also be used to set or predict product pricing by comparing supply and demand. Additionally, the information may be used to document transfer of ownership of the calves. Furthermore, the information may be used as part of a traceability system, such as the United Stated Department of Agriculture's process verified system or to insure accurate country of origin labeling. Finally, the information may be used to analyze each location in an effort to improve each location's efficiency and make each location more profitable.

Therefore, the information can be used to track each calf's physical progression, as well as, each calf's progression through the locations. The calves are preferably considered livestock and bred for slaughter to produce meat products. As a result, each calf may be relocated several times to one of the locations designed to nurture the calves through one of several growth stages in a growth cycle. The locations may be breeding facilities, growyards, feedyards, slaughter facilities, processing plants, distribution facilities, and retail outlets. The calves may also pass through various ranches, livestock operations, and medical facilities.

Each location preferably includes at least one site database and site terminal, in order to facilitate gathering information about the calves. For example, each medical facility needs to be able to enter information relating to medical care given to each calf. Additionally, each slaughter facility needs to be able to enter information relating to how each calf is slaughtered, what types of cuts are derived from each calf, how much meat is derived from each calf, and other information relating to carcass data, such as quality and yield. The slaughter facilities may also perform other tasks, as will be described below, such as ensuring the information relating to each calf is available after the calves have been processed.

The tag attached to each calf is preferably scanned when the calves arrive at each location, prior to the calves leaving each location, and several times during the calves' stay at each location. As discussed above, the tag attached to each calf allows the site terminal to uniquely identify each calf. Therefore, the tag is used to access a unique record in the site database that is created and maintained for storing the information relating to each calf. The tags are preferably associated with the records through a non-repeating numbering strategy that assigns a unique number to each tag. Since the tags are attached to the calves, the number assigned to each tag can be used to uniquely identify the corresponding calf. Additionally, each time the tags are reused, they are assigned a fresh unique number. Thus, each number assigned to each tag and associated with each calf is used only once and can therefore be used to identify each record indefinitely, making information stored in each record available indefinitely.

Each record is preferably updated each time the tags are scanned by entering more recent information into the records. Each time the records are updated, a time, date and operator are preferably associated with the information provided, so that the information may be analyzed over time. For example, when each calf arrives at a specific location, each record is updated to reflect that each calf is now at the specific location, along with the time and date of arrival.

The records may also be updated regularly, such as every hour, every day, or every ten days. Alternatively, the records may be updated somewhat randomly. For example, as discussed above, the input device may include the scale. In this case, the input device may be strategically located between a watering area and a feeding area to alleviate the need for manual scanning and information entry. As the calves pass over the scale, the tag may be automatically scanned and each calf's weight may be updated in the record assigned to that calf. The record is preferably updated to show more recent information as well as older information, such that no information is lost. Therefore, the information in the records preferably show each calf's complete history.

In use, for example, as calves are born, purchased, or otherwise initiated into the system, each calf is tagged, weighed, and examined. The records are individually created for and assigned to the calves and the information is entered into the record. Periodically, the technician may use the scanner to scan the tag attached to each calf to access the site database through the site terminal and update the record for each calf.

Once the central database is updated to reflect the information in the site database over the network, the owner may access the information over the Internet. Thus, the owner may track their calves' progression and access any information in the central database, thereby remotely monitoring their calves. The owner may also use the information in the central database to decide when to relocate their calves, when to slaughter their calves, or both.

When the calves 18 reach the slaughter facility, the tags 22 are preferably removed as the calves 18 are reduced to carcass halves. At this point, each carcass half is preferably assigned a trolley identification (ID) that stays with each carcass half as they are further reduced to individual meat products and by-products. Thus, the trolley IDs can be used to uniquely identify each calf 18 and each calves' 18 individual meat products and by-products, after the tags 22 have been removed.

As the meat products are packaged, the meat products code is preferably included in a label that is attached to each package. Entering the meat products code into the website may allow retailers and/or final consumers to learn a complete history of the meat products they purchase. Thus, documenting the calves progression in a manner that allows the consumers to access the information, assures the consumers high quality meat products and builds product name recognition and brand loyalty.

Additionally, the meat products code may be used for source verification and/or tracing of meat by-products, such as leather. Furthermore, the meat products code may be used in scientific endeavors, such as cloning, using the DNA samples. As such, the meat products code allows virtually anyone with interest in a particular meat product or by-product to learn the complete history of the meat products or by-products in which they have interest.

### BRIEF DESCRIPTION OF THE DRAWINGS

A preferred embodiment of the present invention is described in detail below with reference to the attached drawing figures, wherein:

FIG. 1 is a block diagram of a livestock information system configured in accordance with a preferred embodiment of the present invention;

FIG. 2 is a flow chart depicting an initiation procedure;

FIG. 3 is a flow chart depicting a transportation procedure;

FIG. 4 is a flow chart depicting a calf processing procedure; and

FIG. 5 is a flow chart depicting an information sharing procedure.

### DETAILED DESCRIPTION OF A PREFERRED EMBODIMENT

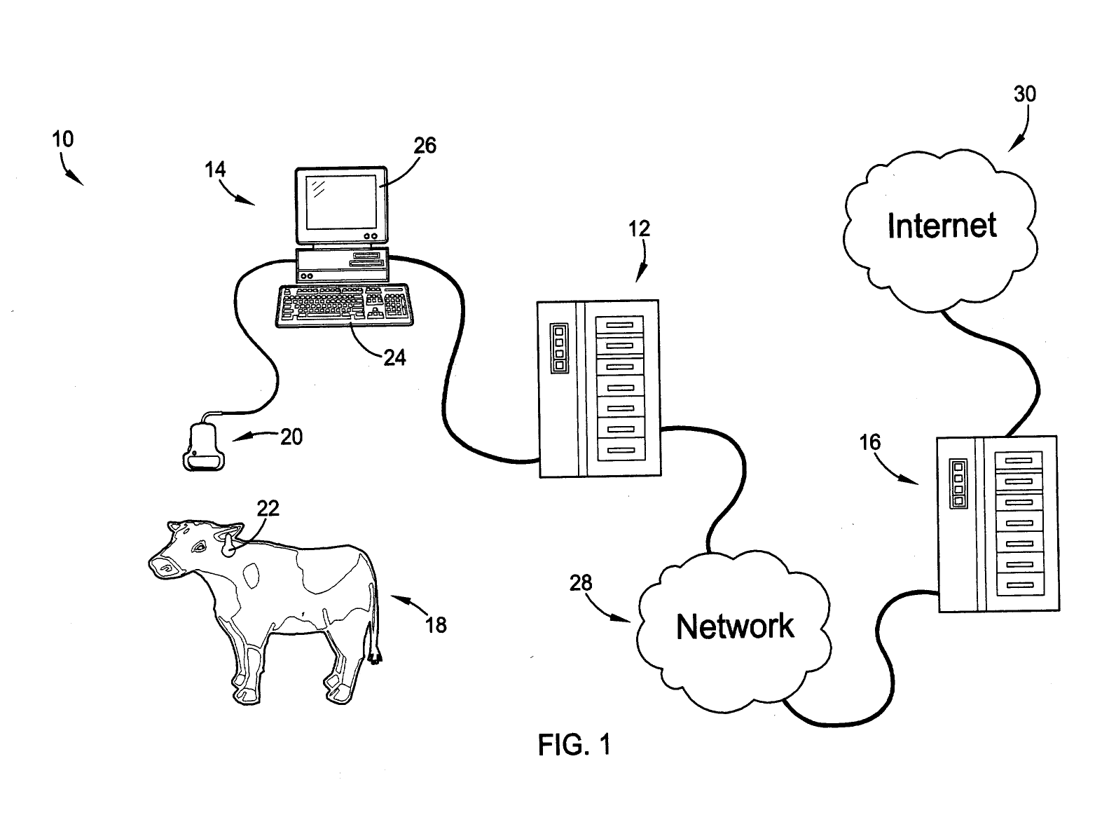

Referring to FIG. 1, the preferred livestock information system 10 configured in accordance with a preferred embodiment of the present invention is illustrated and broadly comprises one or more site databases 12 each accessible by one or more site terminals 14 and a central database 16 or repository for storing information relating to each of a plurality of calves 18. The site databases 12 preferably utilize a conventional database engine, such as Oracle, Sybase, or Microsoft SQL Server. Each site database 12 preferably operates on a server, such as those available from Dell, IBM, and Compaq. Alternatively, each site database 12 may operate on a conventional personal computer (PC), such as those available from Gateway and Hewlett Packard.

The site databases 12 preferably store information about each calf 18 collected through the site terminals 14. The site terminals 14 preferably include or connect to a scanner 20 to scan each of a plurality of unique tags 22 attached to one of the calves 18, an input device 24 to enter information about each calf 18, and a monitor 26 to verify the information entered about each calf 18. The tags 22 are preferably some form of electronically readable tag, allowing each calf 18 to be electronically identified by the scanner 20. For example, the tags 22 are preferably electronic chip tags that respond to radio frequency signals. The scanner 20 is preferably able to transmit and receive the radio frequency signals thereby reading the tags 22 and uniquely identifying each calf 18. Alternatively, the tags 22 may include a bar code unique to each calf 18. In this case, the scanner 20 is preferably able to scan the bar code thereby uniquely identifying each calf 18.

The scanner 20 and tags 22 may also take other forms. For example, the scanner 20 may comprise a retinal scanner and the tags 22 may comprise each calf's eye. It is well known that retinal scans have been found to be useful in uniquely identifying people and animals. In this case, the scanner 20 may be used to initially scan each calf's 18 eye. Data derived from the initial scan may be used to subsequently uniquely identify each calf 18, thereby accomplishing the same function as physically attaching the tags 22 to the calves 18. Alternatively, the scanner 20 may be capable of taking and testing the deoxyribonucleic acid (DNA) samples and the tags 22 may comprise the DNA samples. Similarly, taking initial DNA samples accomplishes the same function as physically attaching the tags 22 to the calves 18.

The tags 22 may also incorporate global positioning satellite (GPS) receivers capable of calculating and transmitting each calf's 18 position along with a unique code assigned to each calf 18. In this case, the scanner 20 may substantially continuously receive each calf's 18 position and code from the tags 22. When a specific calf's position matches a known position, such as adjacent the input device 24, the site terminal 14 may accept the code received by the scanner 20 to uniquely identify the specific calf.

Finally, the tags 22 may be simple visual tags. In this case, the scanner 20 may not be required. A technician may input visual clues from the tags 22, such as color codes or alphanumeric codes, into the site terminal 14 in order to uniquely identify each calf 18. The task of identifying each calf 18 may be done by the technician, the site terminal 14, or a combination of the two. For example, the technician may enter the color code from one of the tags 22 into the site terminal 14. The site terminal 14 may convert the color code, thereby uniquely identifying the calf 18 associated with the color code. While such an approach is possible, it is expected to be human effort intensive and therefore subject to human error. Thus, each calf 18 is preferably efficiently identified using a scanner and tag combination, such as those described above, thereby minimizing human effort and error.

The input device 24 is preferably a conventional keyboard, but may be a touchscreen, a mouse, or any other device commonly used for entering information into a computer. The input device 24 may also be voice activated. Additionally, the input device 24 may include a scale to weigh each calf 18 and automatically enter each calf's 18 weight into the site terminal 14. Furthermore, the input device 24 may include a specialized device designed to collect information about the calves 18, such as a ultrasound device, a thermometer, and/or a height measuring device. The monitor 26 is preferably used in conjunction with the input device 24 to verify the information as it is being entered into the site terminal 14.

In one embodiment, the site terminal 14 and the site database 12 may be combined into a single computer. This embodiment may be efficient for relatively small locations with relatively few calves 18. However, at relatively large locations with large numbers of calves 18, the site database 12 is preferably separate from and communicates with several site terminals 14 each strategically positioned throughout the location.

In another embodiment, the site terminals 14 are small hand-held personal data assistants (PDA), such as those available from Palm, Inc., Handspring, Inc., or similar devices with an integrated infrared (IR) communications port allowing wireless communication with the site database 12. Such devices allow the site terminals 14 to be extremely portable, durable, and easy to operate in harsh outdoor weather conditions, such as summer heat, winter cold, and rain. Additionally, wireless communication alleviates the need for wires which are susceptible to damage, making the entire system 10 more reliable.

In still another embodiment, the site terminals 14 may comprise hand-held computers capable of utilizing Microsoft's Pocket PC operating system, such as those available from Compaq or Toshiba. In this case, the site terminals 14 may incorporate a wireless LAN for communication with the site database 12. It can be seen that such computers share the same advantages as the PDAs described above and may more easily share the information with the site database 12. In this case, the system 10 may be developed with development tools, such as Microsoft's Mobile Internet Toolkit.

The site database 12 preferably periodically transmits information collected about the calves 18 to the central database 16 over a network 28, such as a local area network (LAN) or wide area network (WAN). The site database 12 may automatically initiate a connection with the central database 16 or the central database 16 may automatically initiate the connection with the site database 12. Alternatively, the technician may manually initiate the connection or the connection may be maintained substantially continuously. The connection is preferably a secure network connection, such as a virtual private network (VPN) or a dial-up link. The information may also be encrypted in order to protect the information.

The central database 16 preferably utilizes a conventional database engine, such as Oracle, Sybase, or Microsoft SQL Server. The central database 16 preferably operates on a server, such as those available from Dell, IBM, and Compaq. As discussed above, the central database 16 may receive and store information collected through several site databases 12. Thus, the central database 16 may store information relating to a large number of calves 18 dispersed among several locations spread over a wide geographical area.

The central database 16 is preferably accessible over the Internet 30, thereby making the information stored therein accessible through a website. Thus, the central database 16 and the website allow the information to be accessible from any location with access to the Internet 30. In order to protect the information from unauthorized access, conventional security techniques are preferably used, such as requiring a cattle owner or other user to provide a unique username and a unique password to the central database 16 or the website.

It is important to note that while the network 28 is shown separately from the Internet 30, the network 28 may form some part of the Internet 30 or incorporate some portion of the Internet 30 for the connection. Additionally, the central database 16 may be co-located with one or more of the site databases 14. Therefore, the network 28 may also be completely independent of the Internet 30.

The information may include physical characteristics, such as each calf's 18 weight, height, size, and color. The information may also include genetic information, such as each calf's 18 lineage, blood test results, and information derived from the DNA sample. The information may also include health and treatment information, such as injuries sustained by, diseases contracted by, and vaccinations or other medial care given to each calf 18. The information may also include dietary and nutritional information, such as each calf's 18 feeding habits, growth rate, and body fat percentage. The information may also comprise other data, such as each calf's 18 location and information relating to ownership of each calf 18. Finally, the information may include pictures and images of each calf 18, meat products derived from each calf 18, or both.

The information may be used to make predictions, such as predicting when more supplies are needed at each location by comparing current stock with consumption rates and anticipated increases in consumption rates of the calves 18. The information may also be used to set or predict product pricing by comparing supply and demand. Additionally, the information may be used to document transfer of ownership of the calves 18. Furthermore, the information may be used as part of a traceability system, such as the United Stated Department of Agriculture's process verified system or to insure accurate country of origin labeling. Finally, the information may be used to analyze each location in an effort to improve each location's efficiency and make each location more profitable.

Therefore, the information can be used to track each calf's 18 physical progression, as well as, each calf's 18 progression through the locations. The calves 18 are preferably considered livestock and bred for slaughter to produce meat products. Therefore, each calf 18 may be relocated several times to one of the locations designed to nurture the calves 18 through one of several growth stages in a growth cycle. The locations may be breeding facilities, growyards, feedyards, slaughter facilities, processing plants, distribution facilities, and retail outlets. The calves 18 may also pass through various ranches, livestock operations, and medical facilities.

Each location preferably includes at least one site database 12 and site terminal 14, in order to facilitate gathering and storing information about the calves 18. For example, each medical facility needs to be able to enter information relating to medical care given to each calf 18. Additionally, each slaughter facility needs to be able to enter information relating to how each calf is slaughtered, what types of cuts are derived from each calf, how much meat is derived from each calf, and other information relating to carcass data, such as quality and yield. The slaughter facilities may also perform other tasks, as will be described below, such as ensuring the information relating to each calf 18 is available after the calves 18 have been processed.

The tag 22 attached to each calf 18 is preferably scanned when the calves 18 arrive at each location, prior to the calves 18 leaving each location, and several times during the calves' 18 stay at each location. As discussed above, the tag 22 attached to each calf 18 allows the site terminal 14 to uniquely identify each calf 18. Therefore, the tag 22 is used to access a unique record in the site database 12 that is created and maintained for storing the information relating to each calf 18. The tags 22 are preferably associated with the records through a non-repeating numbering strategy that assigns a unique number to each tag 22. Since the tags 22 are attached to the calves 18, the unique number assigned to each tag 22 can be used to uniquely identify the corresponding calf 18. Additionally, each time the tags 22 are reused, they are assigned a fresh unique number. Thus, each unique number associated with each calf 18 is used only once and can therefore be used to uniquely identify each record indefinitely, making information stored in each record available indefinitely.

For example, the tags 22 may be permanently encoded with a unique tag number. In this case, an animal number is preferably combined with the tag number each time the tags 22 are re-used. Together, the animal number and the tag number form the unique number for each calf 18. The record for each calf 18 may be left open until the calves 18 are slaughtered allowing information to be entered into the record using either the tag number or the unique number. Once the calves 18 are slaughtered, each record is preferably closed, and cannot be accessed using the tag number, such that the tag number subsequently refers to the record for the subsequent calf 18 that wears the tag 22.

Alternatively, the tags 22 may be individually re-programmable and be re-programmed with the unique number every time the tags 22 are reattached to one of the calves 18. In this case, the unique number may be selected from a collection of numbers assigned to the breeding facility, the owner, or another interested party, by the government or some other association. In either case, each record is permanently identifiable and accessible through the unique number.

Therefore, the unique number can be used to refer to each calf 18 indefinitely in all forms of information transfer. For example, in ownership transfers, instead of simply listing a quantity of calves 18 to be sold, a bill of sale could list the unique number for each calf 18 to be sold. In this manner, the unique number functions similarly to a vehicle identification number (VIN) associated with automobiles. Thus, the unique number may be used to uniquely identify individual calves 18 in text files, email, electronic databases and documents, or paper databases and documents.

Each record is preferably updated each time the tags 22 are scanned by entering more recent information into the records. Each time the records are updated, a time, date and operator are preferably associated with the information provided, so that the information may be analyzed over time. For example, when each calf 18 arrives at a specific location, each record is updated to reflect that each calf 18 is now at the specific location, along with the time and date of arrival.

The records may also be updated regularly, such as every hour, every day, or every ten days. Alternatively, the records may be updated somewhat randomly. For example, as discussed above, the input device 24 may include the scale. In this case, the input device 24 may be strategically located between a watering area and a feeding area to alleviate the need for manual scanning and information entry. As the calves 18 pass over the scale, the tag 22 may be automatically scanned and each calf's 18 weight may be updated in the record assigned to that calf 18. The record is preferably updated to show more recent information as well as older information, such that no information is lost. Therefore, the information in the records preferably show each calf's 18 complete history.

The system 10 may also be used with a quality assurance program that governs how the calves 18 are selected and managed, such as that described in co-pending application “QUALITY ASSURANCE PROGRAM AND METHOD FOR MEAT PRODUCTION”, Ser. No. 10/###, ###, filed Oct. ##, 2002. The quality assurance program is expected to only produce high quality meat products and therefore, elevate the meat products above simple commodities. Additionally, using the system 10 to share each calf's 18 complete history assures final consumers that they are purchasing high quality meat products building product name recognition and brand loyalty.

While the present invention has been described above, it is understood that substitutions may be made. For example, the site database 12, the site terminal 14, and the central database 16 have been described as being embodied in three separate computers. For some implementations, it may be desirable for all three to be combined into one computer or hand-held device, which is used to periodically update the website, thereby making the system 10 extremely convenient and easy to manage. Additionally, the central database 16 and/or the central database's 16 connection to the Internet 30 may or may not be required, depending upon implementation. Finally, the system 10 may be used with other livestock, such as sheep, swine, or poultry. These and other minor modifications are within the scope of the present invention.

In use, for example, as calves 18 are born, purchased, or otherwise initiated into the system 10, each calf 18 is tagged, weighed, and examined. The records are individually created for and assigned to each of the calves 18 and the information is entered into the record. Periodically, the technician may use the scanner 20 to scan the tag 22 attached to each calf 18 to access the site database 12 through the site terminal 14 and update the record for each calf 18.

Once the central database 16 is updated to reflect the information in the site database 12 over the network 28, the owner may access the information over the Internet 30. Thus, the owner may track their calves' 18 progression and access any information in the central database 16, thereby remotely monitoring their calves 18. The owner may also use the information in the central database 16 to decide when to relocate their calves 18, when to slaughter their calves 18, or both. Additionally, financial institutions or other interested parties who are given access may use the information in the central database 16 to track the owner's calves 18.

When the calves 18 reach the slaughter facility, the tags 22 are preferably removed as the calves 18 are reduced to carcass halves. At this point, each carcass half is preferably assigned a trolley identification (ID) commonly used with carcass tracking systems, such as Trolley Vision® available from Vande Berg Scales, Inc. The trolley IDs preferably stay with each carcass half as they are further reduced to primals, subprimals, and eventually several individual meat products and by-products. Thus, the trolley IDs can be used to uniquely identify each calf 18 and each calves' 18 individual meat products and by-products, after the tags 22 have been removed.

As the meat products are packaged, a meat products code, such as a bar code, is preferably assigned to each calf 18 and included in a label that is attached to each package. The meat products code may include the number initially assigned to each calf 18 and may be supplemented with a slaughter facility number. Thus, entering the meat products code into the website may allow retailers and/or the consumers to learn a complete history of the meat products they purchase.

Additionally, the meat products code may be used for source verification and/or tracing of meat by-products, such as leather. The meat products code may also be used in scientific endeavors, such as cloning, or as part of a DNA cataloging system using the DNA samples and/or the information derived from the DNA samples. As such, the meat products code allows virtually anyone with interest in a particular meat product or by-product to learn the complete history of the meat products or by-products in which they have interest.

Furthermore, the system 22 may be used for more detailed management and monitoring of the calves 18. For example, where the tags 22 incorporate GPS receivers, the system 10 may monitor motion of the calves 18 to determine health. The tags 22 may also be used to distinguish individual calves 18 and prevent fraud. Finally, the tags 22 may also incorporate other sensors, such as a temperature sensitive chip, thereby allowing the system 10 to automatically gather and combine such information in order to automatically manage and monitor the calves 18.

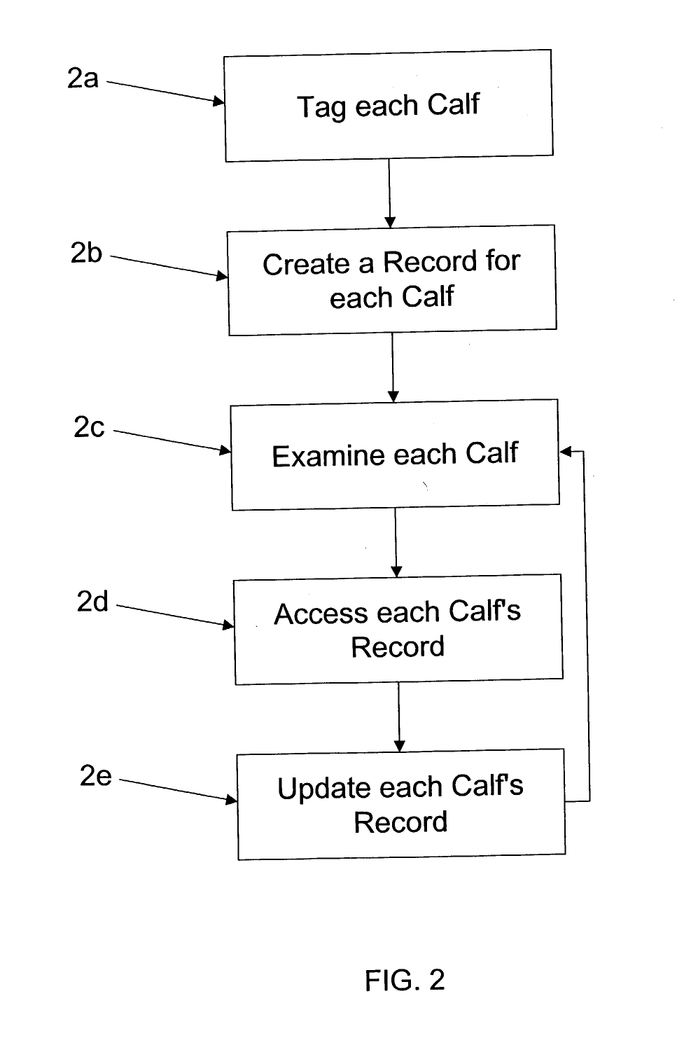

The flow charts of FIGS. 2-5 show the functionality and operation of a preferred implementation of the present invention in more detail. In some alternative implementations, the functions noted in the various blocks may occur out of the order depicted. For example, two blocks shown in succession may in fact be executed substantially concurrently, or may sometimes be executed in the reverse order depending upon the functionality involved.

As a further example of the system 10 and referring also to FIG. 2, the owner may obtain financing from a bank and purchase several calves 18 from a breeder. At the owner's direction, the breeder preferably attaches one of the tags 22 to each calf 18, as shown in step 2a. The breeder also preferably creates records for each of the calves 18 in the site database 12, as shown in step 2b. As the calves 18 progress, they are preferably frequently weighed and otherwise examined, as depicted in step 2c. During, proceeding, or following such examinations each calf's 18 tag 22 is preferably scanned to access each calf's 18 record, as depicted in step 2d. Information obtained during each examination is preferably used to update each record, as depicted in step 2e. As shown in FIG. 2, examining the calves 18 and updating the corresponding records may be repeated several times.

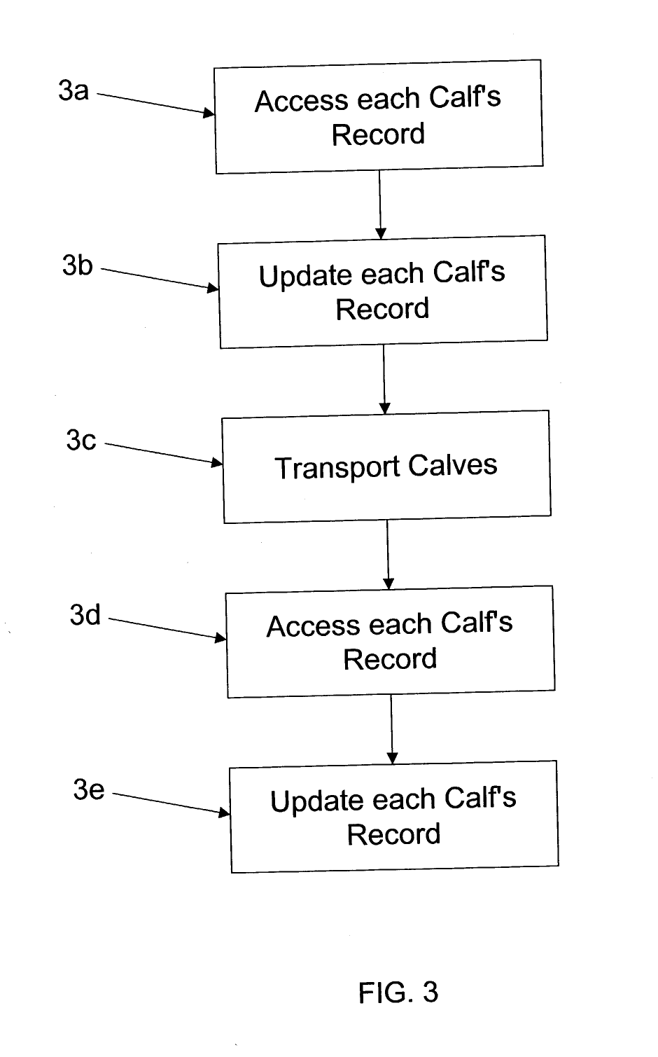

Referring also to FIG. 3, each time the owner wishes to relocate his or her calves 18 to a new location, each calf's 18 tag 22 is preferably scanned to access each calf's 18 record and each record is preferably updated, as depicted in steps 3a and 3b. The calves 18 may then be transported to the new location, as depicted in step 3c. Then, each calf's 18 tag 22 is preferably scanned to access each calf's 18 record and each record is preferably updated to reflect the new location, as depicted in steps 3d and 3e.

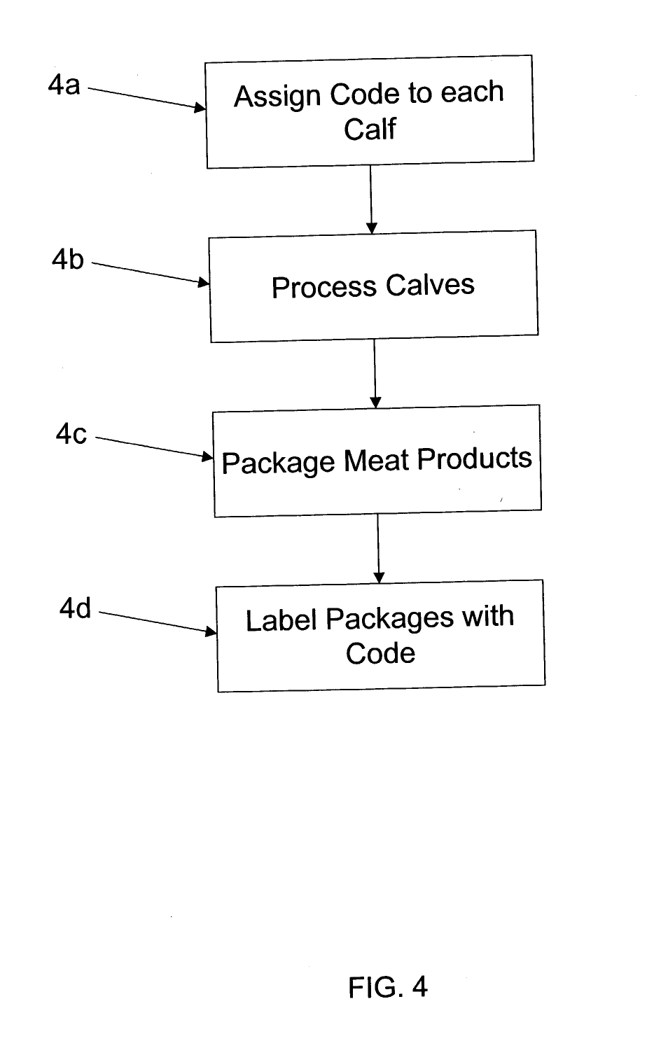

Referring also to FIG. 4, when the owner decides to slaughter his or her calves 18 and transports them to the slaughter facility, the meat products code is preferably assigned to each calf 18, as depicted in step 4a. During processing, the calves 18 may be reduced to several meat products, as depicted in step 4b. While the tags 22 may be removed at some point during processing, the meat products code is preferably kept with the meat products of each calf 18. Once the meat products are packaged, the meat products code is preferably attached to each package, a depicted in steps 4c and 4d.

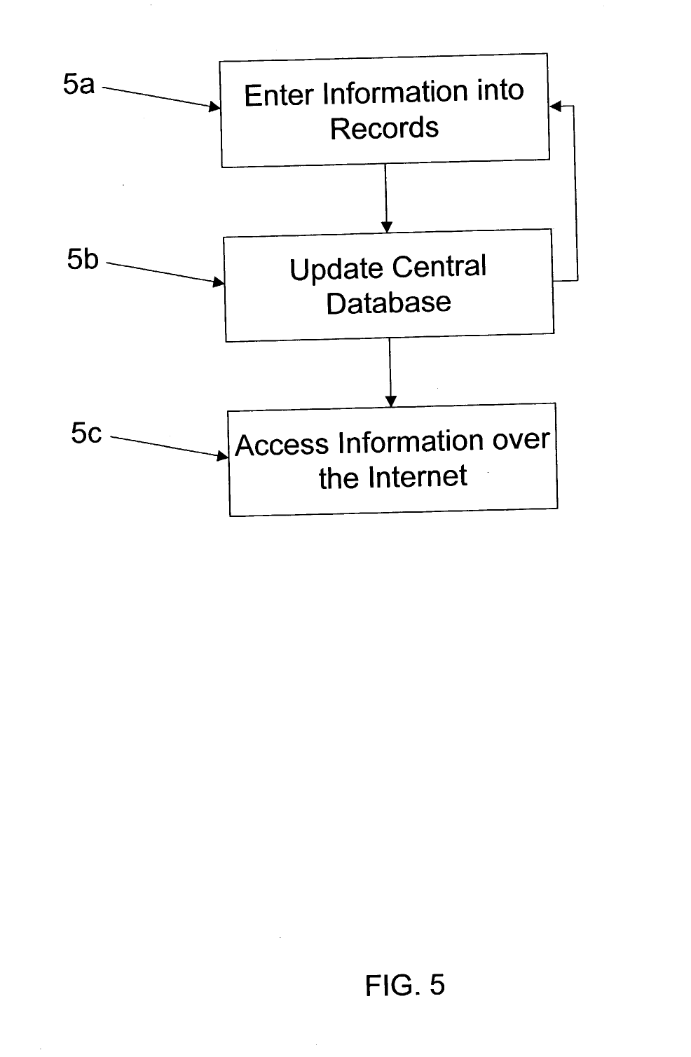

Referring also to FIG. 5, as discussed above, information is preferably entered into the records in the site database 12 through the site terminal 14 using the input device 24, as depicted in step 5a. Information in the site database 12 is preferably periodically transferred to the central database 12 over the network 28, as depicted in step 5b. Information in the central database 12 may be accessed over the Internet 30 by the owner, the bank, the retailer and the final consumer, as depicted in step 5c.

Having thus described a preferred embodiment of the invention, what is claimed as new and desired to be protected by Letters Patent includes the following:

1. A method for gathering and making available information relating to an animal, the method comprising the steps of:
(a) tagging the animal with a tag that can uniquely identify the animal;
(b) creating a record in a database identifiable by the tag;
(c) entering the information relating to the animal in the record; and
(d) ensuring the information contained in the record is available after the animal has been processed.

2. The method as set forth in claim 1, wherein the tag is electronically readable.

3. The method as set forth in claim 1, wherein the information entered in step (c) is selected from the group consisting of—genetic information, health information, treatment information, dietary information, nutrition information, and physical characteristics.

4. The method as set forth in claim 1, wherein the database is co-located with the animal and information contained in the database is sent to a central repository.

5. The method as set forth in claim 4, wherein the information is sent to the central repository over a secure link.

6. The method as set forth in claim 4, wherein the information is periodically sent to the central repository.

7. The method as set forth in claim 4, wherein the central repository is accessible over the internet.

8. The method as set forth in claim 1, wherein the information is periodically updated to reflect the animal's progression.

9. The method as set forth in claim 8, wherein more recent information does not displace older information such that the animal's progression can be monitored.

10. The method as set forth in claim 1, wherein the information is updated each time the animal is relocated.

11. The method as set forth in claim 10, wherein more recent information does not displace older information such that the animal's progression can be monitored.

12. The method as set forth in claim 1, further including assigning a unique bar code to the record.

13. The method as set forth in claim 12, further including processing the animal into a plurality of meat products, packaging the products into a plurality of packages, and attaching the bar code to each package.

14. The method as set forth in claim 1, wherein the information is entered into the database over a wireless connection.

15. A method for gathering and making available information relating to a calf in a central database, the method comprising the steps of:
(a) tagging the calf with an electronically readable tag that can be scanned to uniquely identify the calf;
(b) creating a record in a site database identifiable by the tag;
(c) entering the information relating to the calf in the record;
(d) updating the information relating to the calf to reflect the calf's progression without losing old information such that the calf's progression can be monitored;
(e) periodically updating the central database to reflect the information in the site database; and
(f) ensuring the information is available after the calf has been processed.

16. The method as set forth in claim 15, wherein the information entered in step (c) is selected from the group consisting of—genetic information, health information, treatment information, dietary information, nutrition information, and physical characteristics.

17. The method as set forth in claim 15, further including assigning a unique bar code to the record.

18. The method as set forth in claim 17, further including processing the calf into a plurality of meat products, packaging the products into a plurality of packages, and attaching the bar code to each package.

19. The method as set forth in claim 15, wherein the information is entered into the site database over a wireless connection.

20. A method for gathering and making available information relating to a calf in a central database, the method comprising the steps of:
(a) entering the information relating to the calf in a site database, including
(i) tagging the calf with an electronically readable tag that can be scanned to uniquely identify the calf,
(ii) creating a record in the site database identifiable by the tag,
(iii) entering information concerning the calf's health in the record,
(iv) entering information concerning the calf's physical characteristics in the record, and
(v) updating the central database to reflect the information in the site database;
(b) updating the information relating to the calf when the calf is relocated, including
(i) scanning the tag to access the record,
(ii) entering information concerning the calf's health in the record,
(iii) entering information concerning the calf's physical characteristics in the record, and
(iv) updating the central database to reflect the information in the site database; and
(c) ensuring information contained in the record is available after the calf has been processed, by
(i) assigning a unique bar code to the record,
(ii) processing the calf into a plurality of meat products,
(iii) packaging the products into a plurality of packages, and
(iv) attaching the bar code to each package.
